(19) United States
(12) Patent Application Publication
(10) Pub. No.: US 2025/0183319 A1
(43) Pub. Date: Jun. 5, 2025

(54) BIPOLAR CURRENT COLLECTOR, BIPOLAR ELECTRODE, BIPOLAR BATTERY, AND METHOD FOR MANUFACTURING BIPOLAR CURRENT COLLECTOR

(71) Applicant: TOYOTA JIDOSHA KABUSHIKI KAISHA, Toyota-shi (JP)

(72) Inventors: Takahiko NAKANO, Nagoya-shi (JP); Yusuke KINTSU, Miyoshi-shi (JP)

(73) Assignee: TOYOTA JIDOSHA KABUSHIKI KAISHA, Toyota-shi (JP)

(21) Appl. No.: 18/882,757

(22) Filed: Sep. 12, 2024

(30) Foreign Application Priority Data
Dec. 5, 2023 (JP) 2023-205288

(51) Int. Cl. H01M 4/66; H01M 4/02; H01M 4/04

(52) U.S. Cl. CPC H01M 4/661; H01M 4/0404; H01M 2004/029

(57) ABSTRACT

The bipolar current collector includes a first metal foil, an adhesive layer, and a second metal foil. The first metal foil has a first principal surface and a second principal surface. The second principal surface is an opposite surface of the first principal surface. The adhesive layer covers the first principal surface. The adhesive layer has electron conductivity. The second metal foil is bonded to the first principal surface by an adhesive layer. The second metal foil has a planar frame shape. The second metal foil is attached along the periphery of the first principal surface.

### CROSS-REFERENCE TO RELATED APPLICATION

This application claims priority to Japanese Patent Application No. 2023-205288 filed on Dec. 5, 2023, incorporated herein by reference in its entirety.

### BACKGROUND

### 1. Technical Field

The present disclosure relates to a bipolar current collector, a bipolar electrode, a bipolar battery, and a method for manufacturing a bipolar current collector.

### 2. Description of Related Art

Japanese Unexamined Patent Application Publication No. 2023-053669 (JP 2023-053669 A) discloses a bipolar current collector.

### SUMMARY

The bipolar current collector is an electrode current collector for a bipolar battery. Hitherto, the bipolar current collector has been manufactured by laminating two types of metal foil. For example, it is desired to reduce the amount of metal used from the viewpoint of effective utilization of resources.

An object of the present disclosure is to reduce the amount of metal used.
1. A bipolar current collector includes a first metal foil, an adhesive layer, and a second metal foil. The first metal foil includes a first principal surface and a second principal surface. The second principal surface is a surface opposite to the first principal surface. The adhesive layer covers the first principal surface. The adhesive layer has electron conductivity. The second metal foil is bonded to the first principal surface by the adhesive layer. The second metal foil has a planar frame shape. The second metal foil is attached along a peripheral edge of the first principal surface.

Since the second metal foil has the frame shape, the amount of metal used is reduced. When the second metal foil has the frame shape, the first principal surface of the first metal foil may be in contact with an electrolyte solution, and therefore the first principal surface may be corroded. Since the adhesive layer covers the first principal surface, the adhesive layer may inhibit the contact between the first principal surface and the electrolyte solution. Since the adhesive layer has conductivity, electrons can be conducted in a thickness direction of the bipolar current collector. The frame-shaped second metal foil may contribute to the sealability of a bipolar battery. Improvement in the sealability is expected by applying a sealant between the second metal foil (frame) and the first metal foil. If there is no second metal foil (frame), the adhesive layer is required to have adhesiveness to the sealant. That is, the material selection range of the adhesive layer and the sealant is narrowed. The presence of the second metal foil (frame) is expected to increase the degree of freedom in terms of the material selection.
2. The bipolar current collector described in “1” above may include, for example, the following configuration.

The first metal foil includes aluminum. The adhesive layer includes a resin material and a conductive filler. The second metal foil includes copper.

In the bipolar current collector described in “2” above, the amount of copper used can be reduced.
3. A bipolar electrode includes the bipolar current collector described in “1” or “2” above, a cathode layer, and an anode layer. The cathode layer is disposed on the second principal surface. The anode layer is disposed on the adhesive layer.

For example, the first principal surface of the first metal foil may be on the anode side and the second principal surface may be on the cathode side. The first principal surface may be on the cathode side and the second principal surface may be on the anode side.
4. A bipolar battery includes a plurality of bipolar electrodes, an electrolyte solution, and a sealant. Each of the bipolar electrodes is the bipolar electrode described in “3” above. The bipolar electrodes are stacked in a thickness direction. The sealant seals the second principal surface and the second metal foil between two of the bipolar electrodes adjacent to each other.
5. A method for manufacturing a bipolar current collector includes the following (a) to (c).
(a) A first metal foil and a second metal foil are prepared.
(b) An adhesive layer is formed by applying an adhesive to one side of the first metal foil.
(c) The bipolar current collector is manufactured by attaching the second metal foil to the adhesive layer.

The adhesive layer has electron conductivity. The second metal foil includes a portion having a planar frame shape. The second metal foil is attached along a peripheral edge of the first metal foil.

Hereinafter, an embodiment of the present disclosure (which may hereinafter be abbreviated as “present embodiment”) and an example of the present disclosure (which may hereinafter be abbreviated as “present example”) will be described. However, the present embodiment and the present example do not limit the technical scope of the present disclosure. The present embodiment and the present example are illustrative in all respects. The present embodiment and the present example are not restrictive. The technical scope of the present disclosure includes all changes that fall within the meaning and scope equivalent to the claims. For example, it is originally planned to extract appropriate configurations from the present embodiment and combine such configurations as appropriate.

Geometric terms (e.g., parallel, vertical, orthogonal, etc.) should not be taken in a strict sense. For example, “parallel” may deviate somewhat from “parallel” in a strict sense. The geometric terms may include, for example, design, work, or manufacturing tolerances or variations. Dimensional relationships in each drawing may not match actual dimensional relationships. The dimensional relationships in each drawing may be changed to facilitate understanding of readers. For example, the length, width, and thickness may be changed. Part of the configuration may be omitted.

Numerical ranges such as “m to n %” include upper and lower limits unless otherwise specified. The range “m to n %” indicates a numerical range of “m % or more and n % or less”. The range “m % or more and n % or less” includes “more than m % and less than n %”.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view illustrating an example of a bipolar current collector according to the present embodiment;

FIG. 2 is a cross-sectional II-II view of FIG. 1;

FIG. 3 is a schematic flowchart of a method of manufacturing a bipolar current collector according to the present embodiment;

FIG. 4 is a conceptual diagram illustrating an example of a manufacturing apparatus according to the present embodiment;

FIG. 5 is a schematic plan view illustrating an example of the first metal foil and the second metal foil;

FIG. 6 is a first schematic plan view showing an example of a second metal foil;

FIG. 7 is a second schematic plan view showing an example of a second metal foil;

FIG. 8 is a schematic cross-sectional view showing an example of a bipolar electrode according to the present embodiment;

FIG. 9 is a schematic cross-sectional view showing an exemplary bipolar battery according to the present embodiment; and

FIG. 10 is a table showing evaluation results.

### DETAILED DESCRIPTION OF EMBODIMENTS

### Bipolar Current Collector

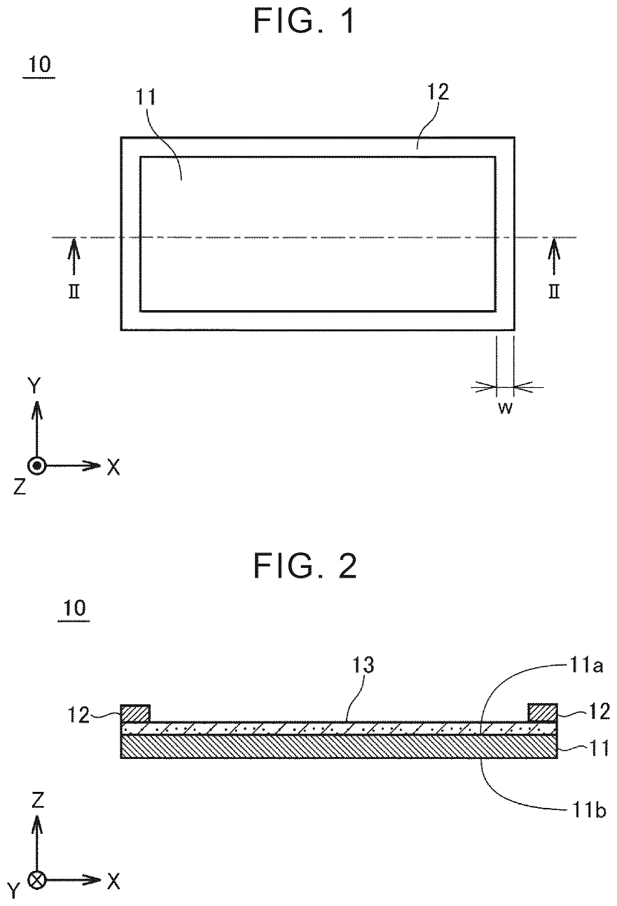

FIG. 1 is a schematic plan view illustrating an example of a bipolar current collector according to the present embodiment. FIG. 2 is a cross-sectional II-II view of FIG. 1. The bipolar current collector 10 includes a first metal foil 11, an adhesive layer 13, and a second metal foil 12. For convenience, the adhesive layer 13 is not shown in FIG. 1. As shown in FIG. 2, the first metal foil 11 has a first principal surface 11a and a second principal surface 11b. The second principal surface 11b is opposite to the first principal surface 11a. The adhesive layer 13 covers the first principal surface 11a. The second metal foil 12 is bonded to the first principal surface 11a by the adhesive layer 13. As shown in FIG. 1, the second metal foil 12 has a planar frame shape. The second metal foil 12 is attached along the periphery of the first principal surface 11a. The second metal foil 12 may have a width dimension (w) of, for example, 1 to 50 mm, 1 to 30 mm, or 1 to 10 mm.

The ratio of the area of the part surrounded by the second metal foil 12 (frame) to the area of the entire first principal surface 11a may be, for example, 0.95 or less, 0.9 or less, 0.8 or less, 0.7 or less, 0.6 or less, 0.5 or less, 0.4 or less, 0.3 or less, or 0.2 or less. The ratio of the same area may be, for example, 0.1 or more, 0.2 or more, 0.3 or more, 0.4 or more, 0.5 or more, 0.6 or more, 0.7 or more, 0.8 or more, or 0.9 or more.

### First Metal Foil and Second Metal Foil

The first metal foil 11 and the second metal foil 12 are made of different materials. The first metal foil 11 and the second metal foil 12 may include any metal material so long as they are dissimilar materials to each other. The first metal foil 11 and the second metal foil 12 may include, for example, at least one selected from the group consisting of aluminum (Al), copper (Cu), nickel (Ni), titanium (Ti), iron (Fe), and stainless steel (SUS).

The first metal foil 11 may include, for example, Al. That is, the first metal foil 11 may be an Al foil. Al foil in the present embodiment includes a pure Al foil and an Al alloy foil. Al foil may comprise, for example, any metallic material represented by alloying numbers from 1000 to 8000 as described in “JISH4000”. The thickness of the first metal foil 11 may be, for example, 1 to 100 μm, 5 to 75 μm, or 10 to 50 μm.

The second metal foil 12 may include, for example, Cu. That is, the second metal foil 12 may be a Cu foil. Cu foil in the present embodiment includes a pure Cu foil and a Cu alloy foil. Cu foil may comprise, for example, any metallic material represented by alloying numbers from 1000 to 7000 as described in “JISH3100”. The thickness of the second metal foil 12 may be, for example, 1 to 50 μm, 3 to 30 μm, or 5 to 10 μm.

### Adhesive Layer

The adhesive layer 13 has electron conductivity. The adhesive layer 13 may include, for example, a resin material and a conductive filler. For example, the adhesive layer 13 may include 1 to 99% by mass of the conductive filler and the remaining resin material. The mass fraction of the conductive filler may be, for example, 5 to 50%, or 10 to 30%.

The resin material is an adhesive component. The resin material may have resistance to an electrolyte solution. The resin material may be insoluble in the electrolyte solution. The resin material may include, for example, at least one selected from the group consisting of olefin-based resin, urethane-based resin, polyamide-based resin, cellulosic resin, polyether-based resin, acrylic resin, epoxy-based resin, and polyester-based resin. The resin material may include, for example, a one-component adhesive, a two-component adhesive, or the like. In the two-component adhesive, the main agent may include, for example, an olefin-based resin. The curing agent may include, for example, a compound having an isocyanate group.

The conductive filler is a conductive component. The conductive filler may include, for example, carbon particles, metal particles, metal plated particles, and the like. The core of the metal plated particles may be solid or hollow resin particles. The conductive filler may include, for example, at least one selected from the group consisting of carbon black, graphite, vapor-grown carbon fibers, carbon nanotubes, carbon nanofibers, carbon nanospheres, Ni particles, Ni plated particles, Cu particles, and Cu plated particles. The particle shape of the conductive filler is arbitrary. The conductive filler may be, for example, spherical, flake-like, rod-like, needle-like, fiber-like, or the like.

The particle size of the conductive filler may be, for example, 0.1 to 10 μm, 0.5 to 5 μm, or 1 to 3 μm. “Particle size” refers to the average value of the maximum ferret size in a particle image. The average value is calculated from 10 or more measurement results. The ratio of the thickness of the adhesive layer 13 to the particle size of the conductive filler may be, for example, 0.5 to 2, or 0.8 to 1.2. The thickness of the adhesive layer 13 may be, for example, 1 to 10 μm, 1 to 5 μm, or 2 to 4 μm. When the thickness of the adhesive layer 13 is 2 μm or more, it is expected that the permeation resistance to the electrolyte solution is improved.

### Penetration Resistance

The penetration resistance indicates the resistance when electrons flow so as to penetrate the first metal foil 11 and the adhesive layer 13 in the thickness direction. The penetration resistance of the bipolar current collector 10 may be, for example, 150 mΩ or less. The penetration resistance may be, for example, 125 mΩ or less, 100 mΩ or less, or 75 mΩ or less. The penetration resistance may be, for example, 10 mΩ or more, or 50 mΩ or more.

### Method for Producing Bipolar Current Collector

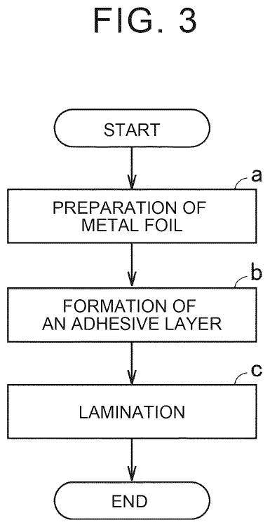

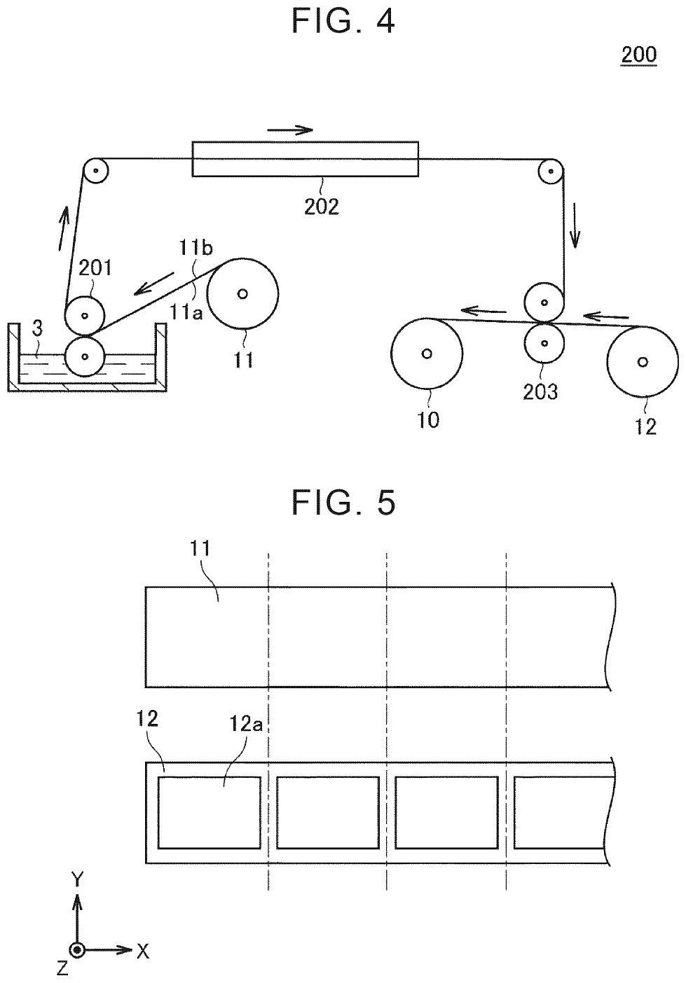

FIG. 3 is a schematic flowchart of a method for manufacturing a bipolar current collector according to the present embodiment. Hereinafter, the “method for manufacturing a bipolar current collector according to the present embodiment” may be abbreviated as “the present manufacturing method”. The manufacturing method includes “(a) preparation of a metal foil”, “(b) formation of an adhesive layer”, and “(c) lamination”. Note that the order of FIG. 3 is merely an example. For example, the multiple steps may proceed concurrently. For example, the multiple steps may occur one after the other. FIG. 4 is a conceptual diagram illustrating an example of a manufacturing apparatus according to the present embodiment. The manufacturing apparatus 200 may implement the present manufacturing method. The bipolar current collector 10 may be manufactured by, for example, a roll t o roll method. An arrow in FIG. 4 indicates a conveyance direction of the workpiece.

### (a) Preparation of Metal Foil

FIG. 5 is a schematic plan view illustrating an example of the first metal foil and the second metal foil. The manufacturing method includes preparing the first metal foil 11 and the second metal foil 12. As the first metal foil 11, for example, a strip-shaped Al foil may be prepared.

The second metal foil 12 is prepared to include a portion having a planar frame shape. In the second metal foil 12, a portion having a planar frame shape may be singular or plural. For example, the second metal foil 12 may be manufactured by punching. For example, a strip of Cu foil may be provided. For example, punching may be performed at a constant pitch along the length of the strip-shaped Cu foil. The punched-out part 12a may be reused, for example, in the production of Cu foils.

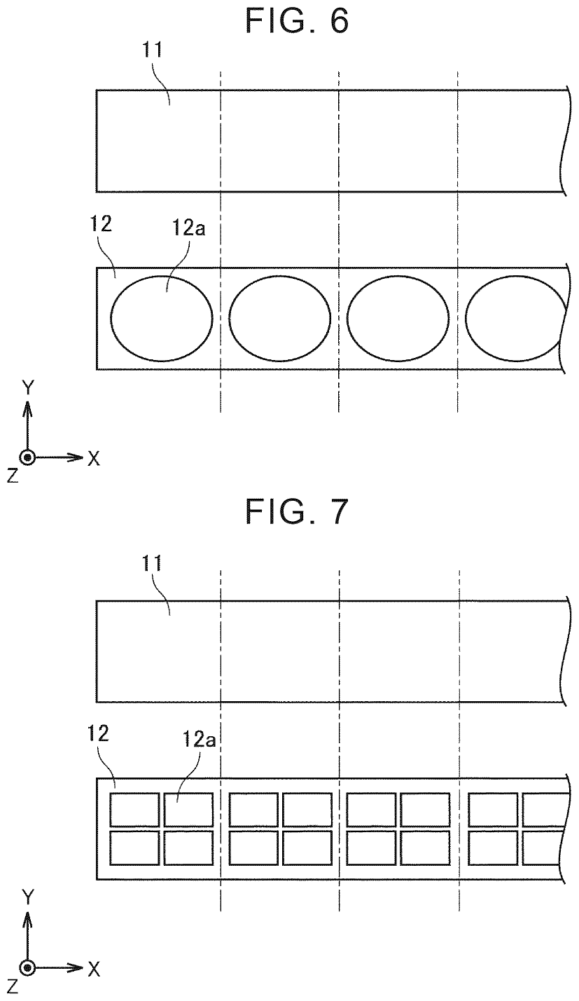

The planar geometry of the punched-out part 12a is optional so long as the punching is carried out so that a frame-shaped part is formed. The planar shape of the punched-out part 12a may be, for example, a rectangular shape. FIG. 6 is a first schematic plan view showing an example of the second metal foil. The planar shape of the punched-out part 12a may be, for example, an elliptical shape, a circular shape, or the like. FIG. 7 is a second schematic plan view illustrating an example of the second metal foil. For example, a metal foil may be left so as to cross-link two sides (frames) facing each other.

### (b) Formation of an Adhesive Layer

The manufacturing process includes forming the adhesive layer 13 by applying the adhesive 3 to one side (the first principal surface 11a) of the first metal foil 11. For example, the adhesive 3 may be prepared by mixing a main agent, a curing agent, and a conductive filler. The coating method is arbitrary. For example, as shown in FIG. 4, the adhesive 3 may be applied to the first metal foil 11 by the gravure roll 201. The adhesive 3 may be dried by, for example, a drying furnace 202.

### (c) Lamination

The manufacturing method includes manufacturing the bipolar current collector 10 by attaching the second metal foil 12 to the adhesive layer 13. For example, the bonding may be performed by dry lamination. For example, the second metal foil 12 may be bonded to the first metal foil 11 by the thermal roll 203. The second metal foil 12 is attached along the periphery of the first metal foil 11 (the first principal surface 11a).

The bipolar current collector 10 may be cut to conform to the electrode shape. The cutting may be performed before the formation of the cathode layer 21 and the anode layer 22, or after the formation of the cathode layer 21 and the anode layer 22. The dashed-dotted line in FIGS. 5 to 7 represents an example of a cutting line.

### Bipolar Electrode

FIG. 8 is a schematic cross-sectional view illustrating an example of a bipolar electrode according to the present embodiment. The bipolar electrode 20 is an electrode for a bipolar battery. The bipolar electrode 20 includes a bipolar current collector 10, a cathode layer 21, and an anode layer 22. The cathode layer 21 is disposed on the second principal surface 11b. The “on the second principal surface 11b” may be referred to as the second principal surface 11b. The same applies to “on the adhesive layer 13” described later.

The cathode layer 21 includes a positive electrode mixture. The positive electrode mixture may include, for example, a positive electrode active material, a conductive material, a binder, and the like. The positive electrode active material may include, for example, a lithium nickel composite oxide, lithium iron phosphate, and the like. The conductive material may include, for example, carbon black. The binder may contain polyvinylidene fluoride or the like. The thickness of the cathode layer 21 may be, for example, 10 to 500 μm, 50 to 300 μm, or 100 to 200 μm.

The anode layer 22 is disposed on the adhesive layer 13. The anode layer 22 may have a larger area than the cathode layer 21. The ratio of the area of the anode layer 22 to the area of the cathode layer 21 may be 1.05 to 1.15, for example. The anode layer 22 may extend to cover a portion of the second metal foil 12. The anode layer 22 includes a negative electrode mixture. The negative electrode mixture may include, for example, a negative electrode active material, a conductive material, a binder, and the like. The negative electrode active material may contain, for example, graphite, silicon, silicon oxide, or the like. The conductive material may include, for example, carbon black. The binder may include styrene-butadiene rubber, carboxymethyl cellulose, and the like. The thickness of the anode layer 22 may be, for example, 10 to 500 μm, 50 to 300 μm, or 100 to 200 μm.

### Bipolar Battery

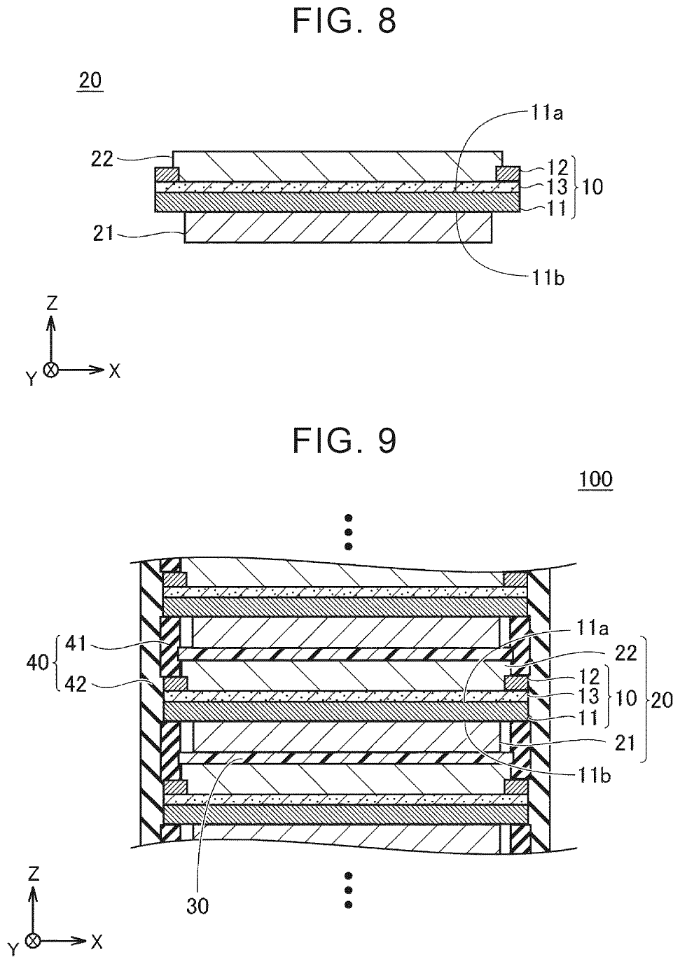

FIG. 9 is a schematic cross-sectional view illustrating an example of a bipolar battery according to the present embodiment. The bipolar battery 100 includes a bipolar electrode 20, an electrolyte solution (not shown), and a sealant 40. The bipolar battery 100 may include, for example, an exterior body (not shown). The exterior body may contain the bipolar electrode 20 and the electrolyte solution. The exterior body may be, for example, a pouch made of a metal foil laminate film, a case made of metal, or the like.

The electrolyte solution is a liquid electrolyte. The electrolyte solution may include, for example, a support salt and a solvent. The support salt may include, for example, LiPF₆. The solvent may include, for example, ethylene carbonate, ethyl methyl carbonate, dimethyl carbonate, diethyl carbonate, and the like. The electrolyte solution may further contain an optional additive.

The plurality of bipolar electrodes 20 are stacked in the thickness direction (Z direction). The bipolar battery 100 may further include a separator 30. The separator 30 is disposed between the cathode layer 21 and the anode layer 22. The separator 30 separates the cathode layer 21 from the anode layer 22. The separator 30 may include, for example, a porous film made of resin.

The sealant 40 seals between the second principal surface 11b and the second metal foil 12 (frame) between two neighboring bipolar electrodes 20. In XY plane, the sealant 40 surrounds the cathode layer 21 and the anode layer 22. The sealant 40 may include, for example, a first sealant 41 (primary sealing) and a second sealant 42 (secondary sealing). The first sealant 41 may seal between the second principal surface 11b and the second metal foil 12. The second sealant 42 may further seal the outside of the first sealant 41. The sealant 40 includes, for example, a resin material. The sealant may include, for example, at least one selected from the group consisting of polypropylene, polyphenylene sulfide, and modified polyphenylene ether. The second sealant 42 may be the same material as the first sealant 41, or may be a different material.

### Preparation of Samples

No. 1

The following materials were prepared.
first metal foil 11: Al foil
Second metal foil 12: Cu foil (punched, punched-out part 12a: rectangular)
Main agent: olefin resin
Curing agent: Isocyanate Compounds
Conductive fillers: Ni plated grains

The adhesive 3 was prepared by mixing the main agent, the curing agent, and the conductive filler. The first metal foil 11, the second metal foil 12, and the adhesive 3 were set in the manufacturing apparatus 200 (see FIG. 4). The bipolar current collector 10 was manufactured under the following conditions.

Line speed (workpiece transfer speed): 15 m/min
Gravure Roll 201: Elon Gate, 75 Lines
Setting temperature of the drying furnace 202: 150° C.
Surface temperature of the thermal roll 203: 90° C.
Nip pressure of hot roll 203: 0.45 MPa·
No. 2

The bipolar current collector 10 was manufactured in the same way as No. 1, except that Cu foil (unprocessed, without holes) was used as the second metal foil 12.

### Evaluation

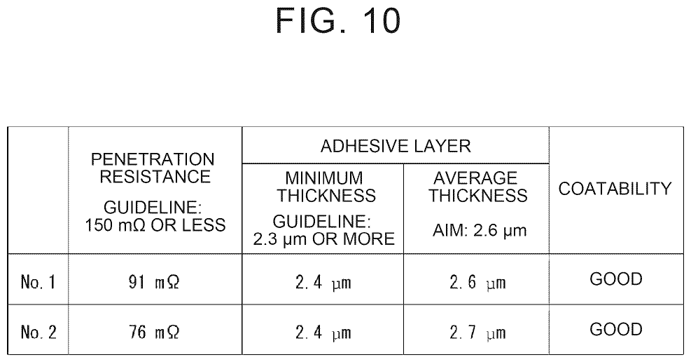

FIG. 10 is a table showing evaluation results. In FIG. 10, “reference” and “target” are values for the sample of the present experiment. No. 1 (frame-shaped Cu foil) showed the same penetration resistance as No. 2 (conventional Cu foil). The quality (minimum thickness, average thickness) of the adhesive layer 13 was also sufficient for No. 1. Therefore, sufficient permeation resistance to the electrolyte solution is expected. In No. 1, the coating property of the mixture was also evaluated by coating the negative electrode mixture on the adhesive layer 13. The coatability of No. 1 was equivalent to that of No. 2.

What is claimed is:

1. A bipolar current collector comprising:
a first metal foil;
an adhesive layer; and
a second metal foil, wherein:
the first metal foil includes a first principal surface and a second principal surface;
the second principal surface is a surface opposite to the first principal surface;
the adhesive layer covers the first principal surface;
the adhesive layer has electron conductivity;
the second metal foil is bonded to the first principal surface by the adhesive layer;
the second metal foil has a planar frame shape; and
the second metal foil is attached along a peripheral edge of the first principal surface.

2. The bipolar current collector according to claim 1, wherein:
the first metal foil includes aluminum;
the adhesive layer includes a resin material and a conductive filler; and
the second metal foil includes copper.

3. A bipolar electrode comprising:
the bipolar current collector according to claim 1;
a cathode layer; and
an anode layer, wherein:
the cathode layer is disposed on the second principal surface; and
the anode layer is disposed on the adhesive layer.

4. A bipolar battery comprising:
a plurality of bipolar electrodes;
an electrolyte solution; and
a sealant, wherein:
each of the bipolar electrodes is the bipolar electrode according to claim 3;
the bipolar electrodes are stacked in a thickness direction; and
the sealant seals the second principal surface and the second metal foil between two of the bipolar electrodes adjacent to each other.

5. A method for manufacturing a bipolar current collector, the method comprising:
(a) preparing a first metal foil and a second metal foil;
(b) forming an adhesive layer by applying an adhesive to one side of the first metal foil; and
(c) manufacturing the bipolar current collector by attaching the second metal foil to the adhesive layer, wherein:
the adhesive layer has electron conductivity;
the second metal foil includes a portion having a planar frame shape; and
the second metal foil is attached along a peripheral edge of the first metal foil.
